(19) United States
(12) Patent Application Publication
(10) Pub. No.: US 2024/0165540 A1
(43) Pub. Date: May 23, 2024

(54) FILTER FOR OIL CONTROL ROBOT

(71) Applicants: Hyundai Motor Company, Seoul (KR); Kia Corporation, Seoul (KR)

(72) Inventors: Sungmin BAE, Jeonju-si (KR); Gi Sung Kwon, Incheon (KR); Sang Hoon Han, Bucheon-si (KR)

(21) Appl. No.: 18/487,466

(22) Filed: Oct. 16, 2023

(30) Foreign Application Priority Data
Nov. 23, 2022 (KR) 10-2022-0157967

(51) Int. Cl. B01D 17/04; B01D 39/18; C02F 1/00; E02B 15/04

(52) U.S. Cl. CPC B01D 17/045; B01D 39/18; C02F 1/001; E02B 15/045; B01D 2239/025; B01D 2239/0421; B01D 2239/1291; C02F 2101/32

(57) ABSTRACT

Provided is a filter for an oil control robot, wherein the filter installed in the oil control robot to filter oil and the filter is formed of hydrophilic nanofibers that absorb water and oil, discharge water, and filter oil.

### CROSS-REFERENCE TO RELATED APPLICATION

This application claims priority from Korean Patent Application No. 10-2022-0157967, filed on Nov. 23, 2022, the disclosure of which is incorporated herein by reference in its entirety.

### TECHNICAL FIELD

The present invention relates to a filter for an oil control robot, and more particularly, to a filter for an oil control robot installed inside the oil control robot to filter oil.

### BACKGROUND

In general, due to an oil spill accident occurring at sea, not only marine ecosystems but also natural ecosystems in beaches, coasts, or coastal areas adjacent to the oil spill accident are damaged. To prevent this, various methods have been used to remove spilled oil from the sea.

In particular, in order to remove oil spilled on the sea surface, oil control robots simultaneously and continuously intake and collect water and oil inside a robot body using characteristics that water and oil are separated by their specific gravities or remove oil by installing an oil absorbent.

FIGS. 1A and 1B are diagrams showing an internal structure of an existing oil control robot. As shown in FIG. 1A, the oil control robot simultaneously intakes water and oil through an intake port 1 on one side thereof, in which, while water and oil pass through a path provided with a partition 2, oil is collected by the partition 2 and water heavier than oil is discharged downwardly through a discharge port 3 at the bottom of the robot body. However, an eddy current occurs inside the robot due to continuous inflow of water and oil, and as a result, oil collected inside the robot is frequently re-discharged.

Therefore, there is need for a filter capable of filtering oil effectively while allowing water to pass through the inside of the oil control robot.

### SUMMARY

The present disclosure attempts to provide a filter for an oil control robot capable of preventing collected oil from being re-discharged by an eddy current occurring inside the oil control robot by applying a filter formed of hydrophilic nanofibers.

In a filter for an oil control robot according to an exemplary implementation, the filter being installed in the oil control robot to filter oil, the filter can be formed of hydrophilic nanofibers that absorb water and oil, discharge water, and filter oil.

The filter can have a filtration capacity with a water and oil separation rate of 166 l/min. or higher, preferably, 275 l/min. to 285 l/min.

The filter can be formed by laminating a cellulose acetate material on a binder.

The cellulose acetate material can have a thickness at which the water and oil separation rate of the filter is not hindered.

The cellulose acetate material can have a thickness such that deviations of a minimum size and a maximum size of pores of the cellulose acetate material are uniform.

A lamination thickness of the cellulose acetate material can be 90 μm to 110 μm.

The filter can filter microplastics having a size of 5 μm or greater.

In some cases, a final filter structure for an oil control robot according to another exemplary implementation includes an upper frame and a lower frame mounted in the oil control robot, the filter according to the exemplary implementation of the present disclosure, disposed between the upper frame and the lower frame, and a mesh cover disposed between each of the upper and lower frames and the filter to protect the filter.

The upper frame and the lower frame can be formed as windows so that the mesh cover and the filter are exposed to the outside from upper and lower portions.

The mesh cover can be formed of a steel material.

According to an exemplary implementation of the present disclosure, when an oil spill accident occurs, automated control can be performed by using a control robot replacing manual control.

In addition, by installing the filter formed of hydrophilic nanofibers inside the control robot, oil can be perfectly or nearly perfectly collected, and the collected oil can be prevented from being re-discharged.

### BRIEF DESCRIPTION OF THE DRAWINGS

FIGS. 1A and 1B are schematic diagrams showing an exemplary internal structure of an oil control robot and flow of water and oil.

FIG. 2 is a view schematically showing an exemplary control robot and a final filter structure installed inside the control robot.

FIG. 3 is a view showing an exemplary manufacturing process of a filter.

FIG. 4 is a graph showing an experimental example of an oil-water separation rate of a filter according to a thickness of a material layer.

FIG. 5 is a view showing an experimental example of a maximum/minimum size of pores of a filter according to a thickness of a material layer.

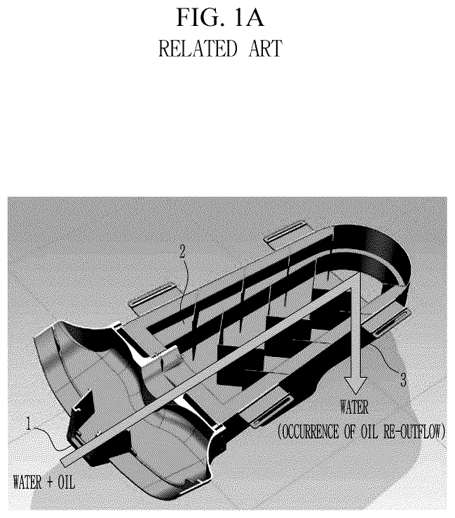

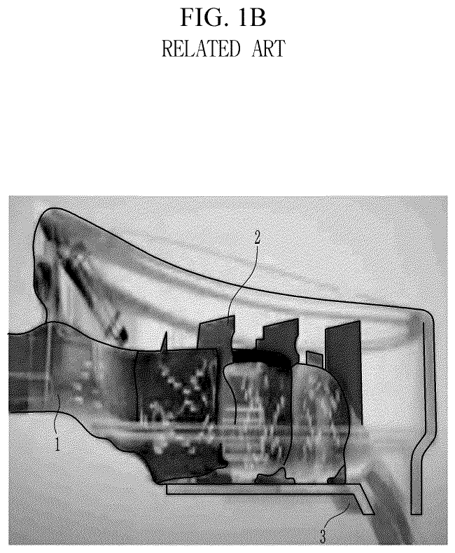

### DETAILED DESCRIPTION

Exemplary implementations of the present disclosure will be described in detail below with reference to the accompanying drawings so that those skilled in the art to which the present disclosure pertains can easily carry out the exemplary implementations. The present disclosure can be embodied in many different forms and is not limited to the exemplary implementations described herein.

In addition, in various exemplary implementations, components having the same configuration are typically described in one exemplary implementation using the same reference numerals, and only component different from the one exemplary implementation will be described in other exemplary implementations.

The drawings are schematic and not drawn to scale. The relative dimensions and ratios of the components in the drawings may be exaggerated or diminished in size for the sake of clarity and convenience, and such arbitrary dimensions are merely illustrative and are not limitative. Furthermore, the same reference symbol is used for the same structure, element or part shown in two or more drawings in order to represent similar features.

The exemplary implementation of the present disclosure specifically represents one exemplary implementation of the present disclosure. As a result, various modifications of the diagram are expected. Accordingly, exemplary implementations are not limited to specific shapes of shown regions, and for example, also include modifications of the shape by manufacturing.

Hereinafter, a filter for an oil control robot and a final filter structure according to an exemplary implementation of the present disclosure will be described in detail with reference to the accompanying drawings.

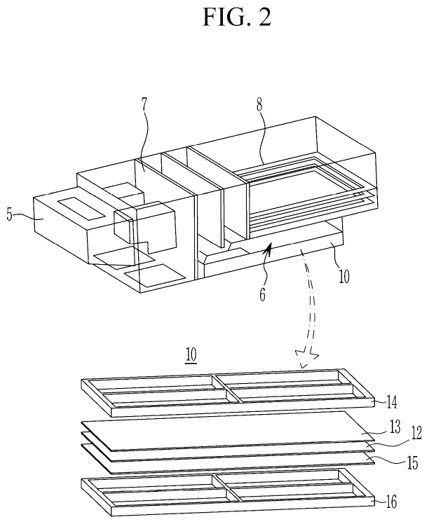

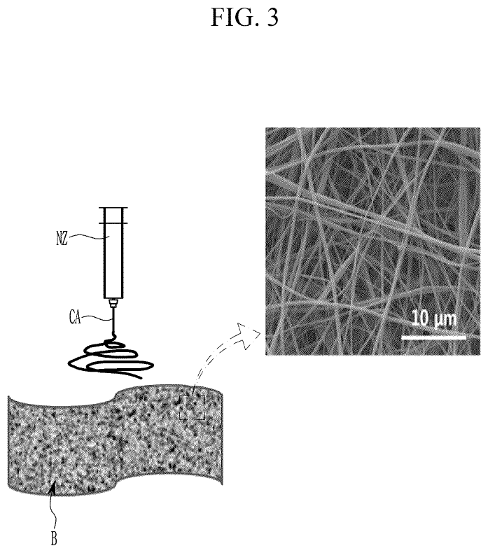

FIG. 2 is a view schematically showing a control robot and a final filter structure installed inside the control robot according to an exemplary implementation of the present disclosure, and FIG. 3 is a view showing a manufacturing process of a filter according to an exemplary implementation of the present disclosure.

Referring to FIG. 2, the control robot according to an exemplary implementation of the present disclosure includes an intake port 5 provided on one side and through which water and oil flow, a plurality of partitions 7 disposed in a direction perpendicular to a flow direction of water and oil inside the robot and preventing oil collected inside the robot from being re-discharged, a plurality of support members 8 installed at a rear end of the partition 7 and arranged in a direction parallel to the flow direction of water and oil, a final filter 10 disposed below the support member 8, allowing water to pass therethrough, and filtering oil, and a discharge port 6 provided below the final filter 10 and discharging water to the outside.

The final filter 10 includes an upper frame 14 and a lower frame 16 so that the final filter 10 can be conveniently mounted inside the oil control robot below the support member 8. A filter 12 is disposed between the upper frame 14 and the lower frame 16, and an upper mesh cover 13 and a lower mesh cover 15 are disposed between the upper frame 14 and the filter 12 and between the lower frame 16 and the filter 12, respectively, to protect the filter.

The upper frame 14 and the lower frame 16 can be formed to have a window shape such that the upper and lower mesh covers 13 and 15 and the filter 12 are exposed to the outside. Therefore, water and oil introduced into the robot pass through the upper frame 14, and only water is absorbed in the filter 12 and passes therethrough, and the passing water can pass through the lower frame 16 to the outside through the discharge port 6.

In addition, the mesh covers 13 and 15 can be formed of steel to ensure rigidity.

The filter 12 serves to intake water and oil, discharge water, and filter oil. To this end, the filter 12 can be formed of hydrophilic nanofibers. Hydrophilic nanofibers only absorb water and pass therethrough and not oil, so when water and oil come into contact with each other, only water is absorbed and passes through, allowing perfect (or near perfect) separation of water and oil.

As the filter 12, a filter having a water and oil separation rate of about 166 l/min. or higher can be used. More preferably, a filter having filtration capacity with the water and oil separation rate of about 275 l/min. to about 285 l/min. can be used.

Referring to FIG. 3, the filter 12 can be manufactured by spraying and applying a cellulose acetate (CA) material onto a binder B through a nozzle NZ. At this time, the cellulose acetate (CA) material can have a thickness at which the water and oil separation rate of the filter is not hindered. In addition, it can be formed of a thickness such that the minimum size and maximum size deviation of the pores of the cellulose acetate (CA) material are uniform.

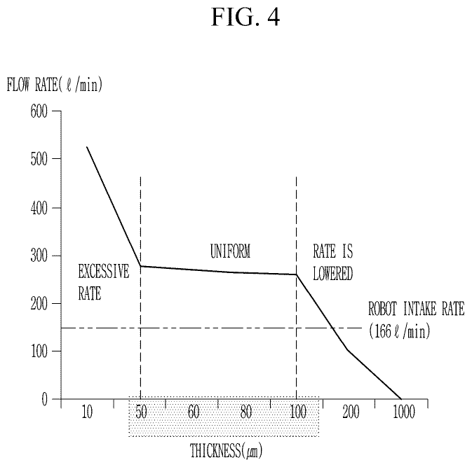

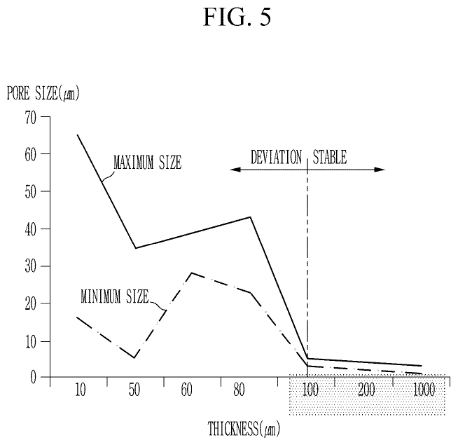

FIG. 4 is a graph showing an experimental example of an oil-water separation rate of a filter according to a thickness of a material layer according to an exemplary implementation of the present disclosure, and FIG. 5 is a view showing an experimental example of a maximum/minimum size of pores of a filter according to a thickness of a material layer according to an exemplary implementation of the present disclosure.

Referring to FIG. 4, when a lamination thickness of the cellulose acetate (CA) material is less than about 50 μm, the water and oil separation rate (flow rate (l/min.)) of the filter 12 is about 280 l/min., changing rapidly to an excessive rate. As the nanofiber filter is laminated to have a small thickness, pores of the filter 12 become larger, increasing a filtration rate, but adversely affecting the ability to filter oil.

In addition, when the lamination thickness of the cellulose acetate (CA) material is 100 μm or greater, the water and oil separation rate of the filter 12 is rapidly dropped to below about 270 l/min.

However, when the lamination thickness of the cellulose acetate (CA) material is about 50 μm to about 100 μm, the water and oil separation rate of the filter 12 is about 270 l/min. to about 280 l/min., maintaining a uniform speed.

At this time, since the water and oil separation rate of the filter 12 needs to be secured to be about 150 l/min. to about 182 l/min., that is, about 166 l/min., the lamination thickness of the cellulose acetate (CA) material should be set to a thickness at which the water and oil separation rate of the filter 12 is not hindered, that is, about 50 μm to about 120 μm.

In addition, referring to FIG. 5, when the lamination thickness of the cellulose acetate (CA) material is less than about 100 μm, minimum and maximum sizes of pores of the cellulose acetate (CA) material can vary and the deviation therebetween may not be uniform.

However, when the lamination thickness of the cellulose acetate (CA) material is about 100 μm or greater, the minimum size and maximum size of pores of the cellulose acetate (CA) material are small and uniform, and the deviation therebetween is uniform to have stable oil-water separation performance.

Therefore, the lamination thickness of the cellulose acetate (CA) material is preferably about 100 μm or greater.

When both the lamination thickness of the cellulose acetate material (CA) for securing the uniform and appropriate oil-water separation rate shown in FIG. 4 and the lamination thickness of the cellulose acetate material (CA) for securing the deviation of the uniform and stable pore sizes shown in FIG. 5 are considered, it is preferable to manufacture with a lamination thickness of about 90 μm to about 110 μm.

As such, according to an exemplary implementation of the present disclosure, when an oil spill accident occurs, automated control can be performed by using the control robot replacing manual control.

In addition, by installing the filter formed of hydrophilic nanofibers inside the control robot, oil can be perfectly or nearly perfectly collected, and the collected oil can be prevented from being re-discharged.

While this disclosure has been described in connection with what is presently considered to be practical exemplary implementations, it is to be understood that the disclosure is not limited to the disclosed exemplary implementations. On the contrary, it is intended to cover various modifications and equivalent arrangements included within the spirit and scope of the appended claims.

What is claimed is:

1. A filter for filtering oil in an oil control robot, comprising:
hydrophilic nanofibers configured to (i) absorb water and oil, (ii) discharge the absorbed water, and (iii) filter the absorbed oil.

2. The filter of claim 1, wherein the filter has a filtration capacity with a water and oil separation rate of 166 l/min. or higher.

3. The filter of claim 1, wherein the filter has a filtration capacity with a water and oil separation rate between 275 l/min. and 285 l/min.

4. The filter of claim 1, wherein the filter comprises a cellulose acetate material that is laminated on a binder.

5. The filter of claim 4, wherein the laminated cellulose acetate material has a thickness at which the water and oil separation rate of the filter is not hindered.

6. The filter of claim 4, wherein the laminated cellulose acetate material has a thickness such that deviations of a minimum size and a maximum size of pores of the laminated cellulose acetate material are uniform.

7. The filter of claim 4, wherein a thickness of the laminated cellulose acetate material is 90 μm to 110 μm.

8. The filter of claim 1, wherein the filter is configured to filter microplastics having a size of 5 μm or greater.

9. A final filter structure for the oil control robot, the final filter structure comprising:
an upper frame and a lower frame disposed in the oil control robot;
the filter of claim 1 disposed between the upper frame and the lower frame; and
a mesh cover disposed between each of the upper and lower frames and the filter and configured to protect the filter.

10. The final filter structure of claim 9, wherein the mesh cover and the filter are exposed to an outside of the final filter structure through the upper frame and the lower frame.

11. The final filter structure of claim 9, wherein the mesh cover is made of a steel material.

12. The final filter structure of claim 9, wherein the upper frame is configured to pass the water and oil, and the lower frame is configured to pass the water and discharge the water to an outside of the oil control robot.

13. The filter of claim 1, further comprising:
an intake port configured to pass the water and oil;
a plurality of partitions configured to prevent the oil from being discharged to the outside of the oil control robot;
a plurality of support members disposed in a direction parallel to a flow direction of the water and oil; and
a discharge port configured to discharge the water to the outside of the oil control robot.

14. The filter of claim 13, wherein the plurality of partitions are disposed in a direction perpendicular to the flow direction of the water and oil.

15. The filter of claim 13, wherein the plurality of support members are disposed at a rear end of the plurality of partitions.
